(19) United States
(12) Patent Application Publication
(10) Pub. No.: US 2008/0030534 A1
(43) Pub. Date: Feb. 7, 2008

(54) Hand Held Micro-fluid Ejection Devices Configured to Eject Fluid without Referential Position Information and Method of Ejecting Fluid

(76) Inventors: Adam Jude Ahne, Carbondale, IL (US); Douglas Laurence Robertson, Lexington, KY (US); Barry Baxter Stout, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/461,834

(22) Filed: Aug. 2, 2006

(51) Int. Cl. B41J 29/38

(52) U.S. Cl. 347/11

(57) ABSTRACT

A hand-held micro-fluid ejection device for manually ejecting fluid droplets onto a substrate during relative translational motion between the ejection device and a target area on the substrate. The ejection device includes a frequency generator to set a designated frequency signal for fluid droplet ejection by the device. The frequency generator is configured to operate open-loop with respect to the relative translational motion between the ejection device and the target area. An electronic processor uses the designated frequency signal to drive a micro-fluid ejection head that produces a predetermine droplet pattern. In some embodiments a manual tuner is provided to adjust the designated frequency. In some embodiments the designated frequency signal includes more than one component to control different elements of fluid being ejected.

### TECHNICAL FIELD

The disclosure relates to the field of micro-fluid ejection devices. More particularly, the disclosure relates to hand-held devices for ejecting fluids onto surfaces that are physically substantially unengaged with the micro-fluid ejection device.

### BACKGROUND AND SUMMARY

It may be desirable to provide a micro-fluid ejection device, for example, a printer, that is manually positioned over a media or substrate surface (such as a piece of paper, cardboard, cloth, wood, plastic, film, or similar material). The device may then be activated to eject fluid, such as ink, to provide text or graphical information on that surface. Ejection of ink in the manner described above is analogous to airbrush painting except that the pattern of ink from the ejection device is controlled to produce textual or graphic images instead of the simple spray “dot” or line produced by an airbrush device. In such applications the ejection device is generally substantially physically unengaged from the media or substrate on which the fluid is deposited. In other words, the physical location, orientation, and motion of the surface with respect to the micro-fluid ejection device are not mechanically controlled either by the ejection device or by an external mechanism.

In order to compensate for this mechanical dissociation between the ejection device and the surface, an optical sensor is sometimes incorporated into the ejection device to track the relative motion of the device as it moves over the surface of the material onto which the fluid is ejected. The foregoing is analogous to the tracking provided by an optical mouse in a computer system. Referential position information regarding the location of the ejection device with respect to substrate surface is provided by the optical sensor to the ejection device, and control circuitry in the ejection device uses this positional data to assist the user in determining when to eject fluid as the ejection device moves over the surface of the substrate.

A display, such as a liquid crystal display (LCD), may be incorporated into the ejection device to provide information to the user regarding the fluid pattern to be ejected. The display may further assist the user in determining when to activate the ejection device.

Unfortunately, the cost of the optical sensor, the LCD display and associated circuitry drives the cost of such ejection devices to a price point that prohibits their use by consumers in many potential applications. Also, problems associated with certain substrate surfaces (such as high gloss media), technical difficulties in accounting for a varying gap between the ejection device and the substrate surface, and technical difficulties in accounting for dramatic speed changes as the user passes the ejection device over the substrate surface, can drastically decrease the desired effect provided by conventional handheld micro-fluid ejection devices. What is needed therefore is a lower cost and simpler micro-fluid election device for ejecting fluid onto a surface that is physically disengaged from the ejection device.

Exemplary embodiments of the disclosure provide [to be completed when the patent claims are finalized].

### BRIEF DESCRIPTION OF THE DRAWINGS

Various advantages are apparent by reference to the detailed description in conjunction with the figures, wherein elements are not to scale so as to more clearly show the details, wherein like reference numbers indicate like elements throughout the several views, and wherein:

FIG. 1 is a schematic perspective of a hand-held micro-fluid ejection device.

FIG. 2A illustrates an arrangement of droplets in a printed pattern for application in a hand-held micro-fluid ejection device.

FIG. 2B illustrates an arrangement of printed patterns in a printed shape for application in a hand-held micro-fluid ejection device.

FIG. 2C illustrates an arrangement of droplets in a printed pattern for application in a hand-held micro-fluid ejection device.

FIG. 2D illustrates text printed by a hand-held micro-fluid ejection device.

FIG. 3 presents a schematic block diagram of a micro-fluid ejection device incorporating a position sensor for control of fluid spacing during translational motion of the ejection device.

FIG. 4 presents a schematic block diagram of a micro-fluid ejection device not incorporating a position sensor for control of fluid spacing during translational motion of the ejection device.

FIG. 5A illustrates a configuration of micro-fluid ejectors for a hand-held micro-fluid ejection device.

FIG. 5B illustrates a combination of pattern strokes formed by the configuration of micro-fluid ejectors of FIG. 5A.

FIG. 5C illustrates a graphic pattern printed by a hand-held micro-fluid ejection device.

FIG. 6 illustrates a text image printed by a hand-held micro-fluid ejection device in a target area of a printing surface.

FIGS. 7A and 7B illustrate images printed by a hand-held micro-fluid ejection device.

FIG. 8A-8D illustrate text images printed by a hand-held micro-fluid ejection device.

FIG. 9 presents a schematic block diagram of micro-fluid ejection device incorporating a position sensor configured for optional control of print spacing during translational motion of the ejection device

FIG. 10 presents a flow chart of a method for printing an image using a hand-held micro-fluid ejection device.

### DETAILED DESCRIPTION OF EXEMPLARY EMBODIMENTS

Described herein are various embodiments of a hand-held micro-fluid ejection device for manually ejecting one or more fluids during relative translational motion between the device and a target area of a substrate surface. Also described herein is a method for manually ejecting fluids during relative translational motion between a hand-held micro-fluid ejection device and a target area of a substrate surface.

As used herein, the term “hand-held” means that the relative translational motion between the substrate surface and the micro-fluid ejection device is at least in part continuously manually controlled by a human operator rather than by a mechanical device.

As used herein, the term “relative translational motion” generally refers to an arrangement where the substrate surface remains substantially stationary relative to a fixed external frame of reference while the micro-fluid ejection device moves to pass over the target area of the substrate surface during fluid ejection. However, in some embodiments the ejection device remains substantially stationary relative to a fixed external frame of reference while the target area of the substrate surface moves under the ejection device. In some embodiments both the substrate surface and the ejection device may move relative a fixed external frame of reference.

It should also be noted that a distance between the substrate surface and the micro-fluid ejection device may vary in the direction orthogonal to the translational motion between the substrate surface and the ejection device. In a hand-held micro-fluid ejection device this gap between the substrate surface and the ejection device may be mechanically controlled (such as by a fixed dimension spacer) or the gap may be under continuous manual control of the operator.

In order to simplify the discussion and provide illustrations of the apparatus and use thereof according to the disclosed embodiments, the following discussion is directed to a micro-fluid ejection device that is a handheld printing device for ejecting ink onto a substrate or media. However, it will be appreciated that the exemplary embodiments may be applied to any handheld micro-fluid ejection device, such as devices used for ejecting cooling fluids, lubricants, pharmaceuticals, and the like on a wide variety of surfaces.

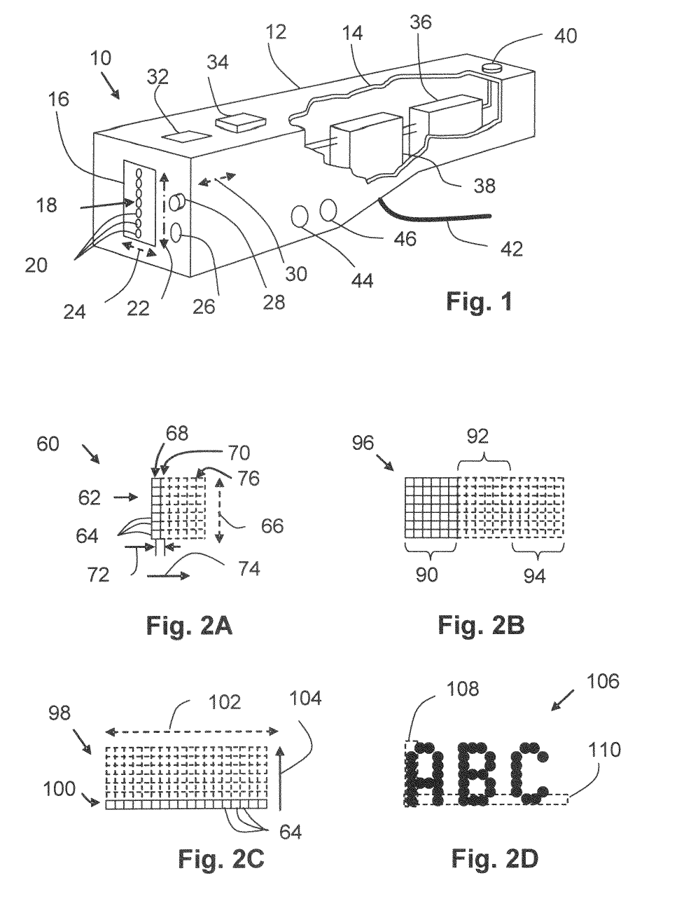

FIG. 1 illustrates an embodiment of a hand-held printing apparatus 10. The printing apparatus 10 has a housing 12, and a cut-away window 14 is depicted in the housing 12 only for illustrative purposes in order to portray certain components inside the housing 12. The printing apparatus 10 has a micro-fluid ejection head 16. The ejection head 16 has a linear array 18 of micro-fluid ejection ports or nozzles 20. The linear array 18 has a longitudinal orientation depicted by reference arrow 22 and an orthogonal lateral orientation depicted by reference arrow 24.

“Translational motion” of the printing apparatus 10 refers to motion in the either the direction of reference arrow 22 or reference arrow 24 or combinations of those directions. Printing apparatus 10 also contains a position sensor 26 that may be used to provide positional data regarding the position and translational motion of the printing apparatus 10.

Printing apparatus 10 may include a display 32 and a “PRINT” button 34 for activating the printing apparatus 10. The display 32 may be used to portray information regarding the image to be printed or a portion thereof, or to portray the status of the printer, or combinations of the foregoing and similar information. The PRINT button 34 is used to provide a print enable signal to the printing apparatus 10 to cause fluid to be ejected from the ejection head 16 through the nozzles 20.

In one exemplary embodiment, the housing 12 of the printing apparatus 10 may include a power supply 36 and a microprocessor 38. An on off button 40 may be provided, and a communication link 42 may be provided to transfer information to be printed from an external source such as a computer or personal digital assistant (PDA) device. Communication link 42 is portrayed in FIG. 1 as a wired link, but in alternative embodiments a wireless communication link may be use. Two print control dials 44 and 46 may be provided for the user of printing apparatus 10 to control various aspects of the printed image such as quality mode, color, and the like.

FIG. 2A illustrates an arrangement of a “pattern” 60 of a portion of an image painted in one embodiment of a hand-held printing apparatus. The pattern 60 includes a linear array 62 of seven droplets 64 oriented in a longitudinal direction depicted by reference arrow 66 and positioned at location 68. The seven droplets 64 correspond to the seven ejection ports 20 of printing apparatus 10 of FIG. 1. Regardless of whether they represent a printed “dot” or a blank spot, the droplets (e.g., 64) that are presented in a linear array (e.g., 68) for print at a single instant of time represent a “print stroke” of the image being printed. The distance between successive locations (e.g., between 68 and 70) is a print stroke spacing distance 72. Each linear array 62 of droplets 64 at each location (68, 70, etc.) defines a print stroke, and ideally the print strokes are substantially parallel.

The number of droplets 64 determines in part the resolution of the printed image, and the number of droplets 64 in some embodiments may be much higher than seven, or it may be lower, but generally a minimum of five droplets 64 is employed in a linear array. After the linear array 62 of droplets 64 is printed, the micro-fluid ejection head 16 (FIG. 1) is moved in the lateral direction 74. Ideally the ejection head moves precisely to location 70 and then sequentially to three parallel locations in lateral direction 74 (which for simplicity are shown but not labeled) and then to location 76. Lateral direction 74 is referred to as the direction of relative translational motion of the hand-held printing apparatus that is printing pattern 60.

When the image to be printed is a text images the pattern 60 represents a character. Typically when seven droplets 64 are used to form a linear array (e.g., 68), five locations are used to form the character, and a sixth location (e.g., 76 in FIG. 2A) is used to form a space between characters. When the image is a graphic image, the pattern 60 represents a portion of the overall image referred to herein as a “block” of graphic information and sometimes no space is provided between blocks of graphic information.

FIG. 2B illustrates an arrangement of three patterns 90, 92 and 94 constituting a “shape” 96 portion of an image printed in one embodiment of a hand-held printing apparatus. When the patterns (e.g., 90, 92 and 94) represent characters of a text image, the shape 96 represents a word. When the patterns (e.g., 90, 92 and 94) represent blocks of a graphic image, the shape 96 represents a portion of the overall image referred to herein as a “sector.”

FIG. 2C represents an arrangement of a pattern 98 of an image in an alternative embodiment of a hand-held printing apparatus. In this arrangement, a linear array 100 of eighteen droplets 64 is depicted. Linear array 100 has a longitudinal orientation indicated by reference arrow 102. Linear array 100 is moved in direction 104 in six successive subsequent iterations to construct pattern 98.

FIG. 2D illustrates text 106 printed by a hand-held printing apparatus. Text 106 may be constructed starting with an initial print stroke 108 using pattern 60 of FIG. 2A, or text 106 may be constructed starting with an initial print stroke 110 using pattern 98 of FIG. 2C.

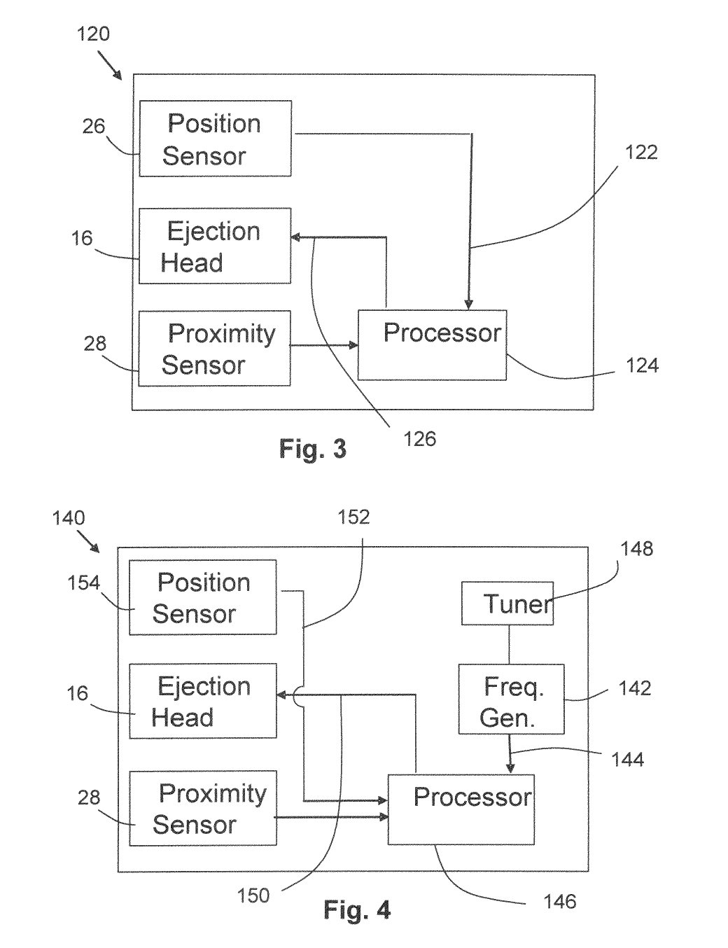

FIG. 3 presents a block diagram of a printing apparatus 120 incorporating a position sensor 26 for control of print spacing during translational motion of the printing apparatus 120. Typically positional data 122 comprising two-channel quadrature signals are supplied to a processor 124. Both direction and velocity information may be discerned from positional data 122. In some embodiments, positional data 122 may include coordinate information. The processor 124 typically knows the print stroke spacing distance (e.g., 72 in FIG. 2A) used by the ejection head 16 and the processor 124 divides the velocity component of positional data 122 by the print stroke spacing distance to set a print stroke frequency for print trigger signals 126 that are sent to the ejection head 16. The print trigger signals 126 embody the print stroke frequency as well as plurality of linear arrays of droplets representative of the image data that are to be printed in each print stroke. The ejection head 16 uses the print trigger signals 126 to prints a series of print strokes at the print stroke frequency and thereby print the desired image.

FIG. 4 presents a block diagram of a printing apparatus 140 that does not incorporate the position sensor 26 for control of print spacing during translational motion of the printing apparatus 140. In this embodiment, a frequency generator 142 produces a designated frequency spectrum signal 144 at a designated frequency that is fed to a processor 146. Generally the designated frequency is set by dividing the intended print stroke spacing distance (e.g., 72 in FIG. 2A) by an expected translational velocity of the printing apparatus 140. For example, if the expected translational velocity of a hand-held printing apparatus is ten centimeters per second, and the print stroke spacing distance is one tenth of a millimeter, a designated frequency of one thousand print strokes per second may be set.

In some embodiments frequency generator 142 may be configured to produce a designated frequency spectrum signal 144 in a format that mimics the positional data 122 produced by position sensor 26 of FIG. 3. That configuration permits the use of processor 146 that is equivalent to the processor 124 of FIG. 3.

In other exemplary embodiments a tuner 148 may be provided to manually adjust the designated frequency of frequency generator 142. The adjustment feature of tuner 148 is easily accessible to the user, such as by means of the print control dials 44 and 46 of FIG. 1. The processor 146 provides print trigger signals 150 at the designated frequency to ejection head 16. The print trigger signals 150 embody the print stroke frequency as well as plurality of linear arrays of droplets representative of the image data that are to be printed in each print stroke.

In another exemplary embodiment, position information 152 may be provided to processor 146 by a position sensor 154 in the printing apparatus 140. The position information 152 may be used by the processor 146 to determine whether or not to send print trigger signals 150 to the ejection head 16. For example, if the position information 152 indicates that the ejection head 16 is within the target area of the printing surface, processor 146 may be programmed to proceed to generate print trigger signals 150 for the ejection head 16. Alternately, if the position information 152 indicates that the ejection head 16 is outside of the target area of the printing surface, processor 146 may be programmed to not generate print trigger signals 150 for the ejection head 16.

Note however, that in the foregoing configurations the processor 146 is not configured to use position information 152 to modify the designated frequency of designated frequency spectrum signal 144. The absence of configuration to modify a designated frequency of the designated frequency spectrum signal (e.g., 144) based upon positional information (e.g., 152) from a position sensor (e.g., 154) is a condition referred to herein as one where the frequency generator (e.g., 142) is configured to operate open-loop with respect to the relative translational motion between the printing apparatus and the target area.

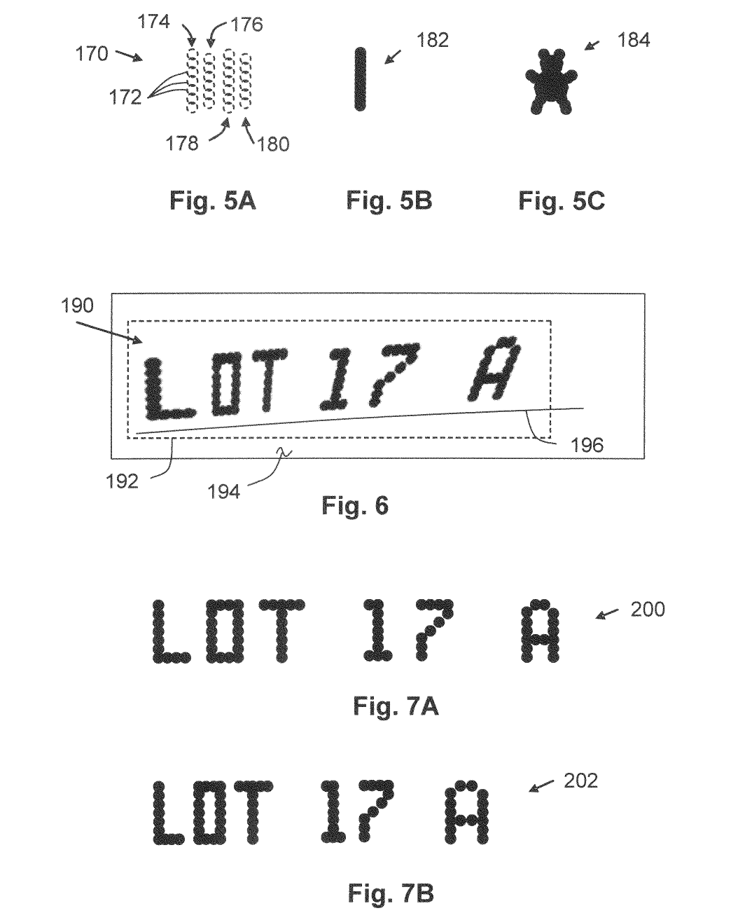

Turning now to FIGS. 5A, 5B and 5C, factors are illustrated that relate to the print quality of a printing apparatus regardless of whether the printing apparatus incorporates a position sensor for control of print spacing during translational motion of the printing apparatus. FIG. 5A depicts an arrangement of linear arrays 170 of micro-fluid ejection ports 172. The linear arrays 170 include a first primary linear array 174, a first fill-in linear array 176, a redundant basic linear array 178 and a redundant fill-in linear array 180. The fill-in arrays 176 and 180 are designed to smooth out image strokes made by the printing apparatus. The redundant arrays 178 and 180 are designed to preserve print quality if a micro-fluid ejector in the primary array fails. It is generally important to accurately control the alignment (registration) of a redundant linear array with its companion original linear array to maintain suitable print quality. Such accurate alignment may be difficult with a printing apparatus that does not incorporate a position sensor for control of print spacing during translational motion of the printing apparatus. Consequently, such printers may be constructed with a micro-fluid ejection head that includes redundant linear arrays, since such ejection heads are generally available at reasonable cost, but the redundant arrays in the ejection heads may be disabled in these printers.

FIG. 5 B illustrates an overlay 182 of four printing strokes from linear arrays 170, indicating the improved print quality provided by that configuration. FIG. 5C illustrates a graphic pattern 184 printed by linear arrays 170, indicating a graphic resolution that is achievable with that configuration.

In practice, it may be desirable to use a much higher quantity and higher density of ejector ports that depicted in FIG. 5A. FIG. 6 presents a reproduction of text 190 printed in a target area 192 of a printing surface 194. The image 190 was printed with a printing apparatus that did not incorporate a position sensor for control of print spacing during translational motion of the printing apparatus. The print quality is acceptable even though the width of the characters appears to be slightly irregular and the path 196 of the text is not precisely straight. In many applications such variations are desired features that avoid the appearance of robotic automation and instead reflect an artistic flair.

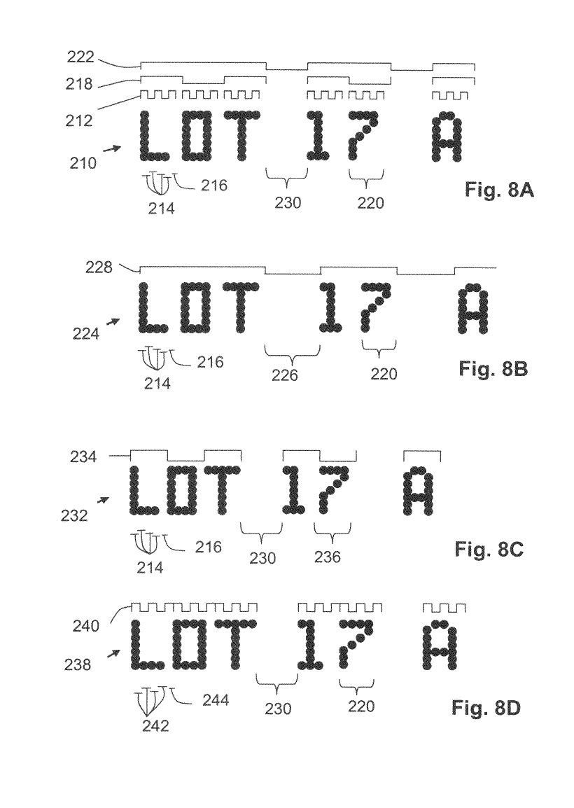

FIGS. 7A, 7B and 8A-8D illustrate printing features that may be controlled by a printing apparatus that does not incorporate a position sensor for control of print spacing during translational motion of the printing apparatus in a manner. FIG. 7A depicts (for reference purposes) text 200 printed by a printing apparatuses operating at a print stroke frequency that is uniform and substantially equal to its translational velocity divided by a desired print stroke spacing. Consequently, the print strokes within the characters and the spacing between the characters in text 200 of FIG. 7A are substantially uniform and equally spaced.

FIG. 7B depicts text 202 printed by a printer where the print stroke frequency is not substantially equal to its translational velocity divided by the print stroke spacing established in FIG. 7A. For example, the print stroke frequency exceeded the expected translational velocity divided by the print stroke spacing when the letter “L” of text 202 was printed in FIG. 7B, causing the droplets in adjacent strokes to be closer together than when the “L” was printed in FIG. 7A. The print stroke frequency was less than the expected translational velocity divided by the print stroke spacing when the letter “A” of text 202 was printed in FIG. 7B, causing the droplets in adjacent strokes to be further apart than when the “A” was printed in FIG. 7A. These variations and methods of controlling them are analyzed more precisely in FIGS. 8A-8D.

FIGS. 8A-8D present representations of text that has been printed using a hand-held printing apparatus moving in a straight line at a constant velocity. These simplifications are incorporated in order to highlight the effects of other variables in the printing process. FIG. 8A depicts text 210 that is printed using a designated frequency of print stroke pulses 212 to time each printing stroke. Each character in the text comprises five print strokes. For example, the character “L” has four print strokes 214 that print “dots” that form the letter, and a fifth stroke 216 that is blank. Each character is printed using a designated frequency of character pulses 218.

In FIG. 8A the width of character pulses 218 is set at the width of six print stroke pulses 212, which inserts a blank space equal to the print stroke width between each character. The characters “L,” “O.” “T.” “1,” etc. of text 210 are examples of “macro elements” of the image, since they are composed of combinations of the most basic element—the print stroke The frequency of the character pulses 218 is referred to as a macro element frequency. The width 220 of the character pulses 218 is referred to as a macro element spacing distance. The character pulses 218 may be provided by a printing apparatus's electronic processor to the printing apparatus's ejection head as a component of the print trigger signals in the same manner that print stroke pulses are sent as print trigger signals.

Continuing with FIG. 8A, the text 210 also comprises three words: “LOT,” “17” and “A.” The words are different lengths, but a series of word pulses 222 is used to signal the start of each word. Although these pulses do not occur at a fixed frequency, the width of the high-to-low-to-high word pulses 222 are fixed and consequently the word pulses 222 are considered to be at a “designated frequency.” Furthermore, since the words (“LOT,” “17” and “A”) are composed of combinations of the most basis element—the print stroke—the words are examples of macro elements of the image. Consequently, the designated frequency of the word pulses 222 are referred to as a macro element frequency. The combination of the designated frequency of stroke pulses 212 and the designated frequency of character pulses 218 and the designated frequency of word pulses 222 are referred to as the designated frequency spectrum of the printing apparatus that produced text 210. In another embodiment, a designated frequency spectrum may consist of only one designated frequency, such as the print stroke frequency.

FIG. 8B illustrates how one macro element frequency may be varied without changing another macro element frequency or the print stroke frequency. In FIG. 8B, text 224 has been printed in a manner where the width 226 of the high-to-low-to-high word pulses 228 is longer than the width 230 of the high-to-low-to-high word pulses 222 of FIG. 8A. The rest of the designated frequencies are the same in FIG. 8B as in FIG. 5A.

In FIG. 8C, text 232 is printed in a manner where only the frequency of the character pulses 234 has been varied compared to the designated frequencies of FIG. 8A. The frequency of the character pulses 234 is slightly higher than the frequency of the character pulses 218 of FIG. 8A, or to put it another way, the width of the character pulses of text 232 (e.g., width 236) in FIG. 8C is slightly shorter than the width of the character pulses of text 210 (e.g., width 220) of FIG. 8A. The rest of the designated frequencies are the same in FIGS. 8C and 8A.

In FIG. 8D text 238 has been printed using print stroke pulses 240 that are longer than the print stroke pulses 212 of FIG. 8A. To put it another way, the width of print strokes 242 and 244 of text 238 are wider than the width of print strokes 214 and 216 of FIG. 8A. The rest of the designated frequencies are the same in FIGS. 8D and A. For the specific text 238 of FIG. 8D this change in print stroke pulse width produces acceptable results, but there is no space between the characters so that any adjoining full-width (five print stroke) characters may abut each other.

While FIGS. 8A-8D illustrate concepts for multiple designated frequencies in a designated frequency spectrum for printing textual matter, it is to be understood that the same process may be used to print graphical matter. In printing graphical matter print strokes are used to print patterns that represent a portion of the overall image. These patterns are referred to herein as “blocks.” A block may be a graphic pattern such as graphic pattern 184 in FIG. 5C. Blocks may be combined to produce graphical “sectors” in a manner analogous to combining text characters into words. Graphical images produced in this manner by a hand-held printing apparatus may be very complex, including images in two dimensions, such as images like those associated with quilt patterns or even full color raster images.

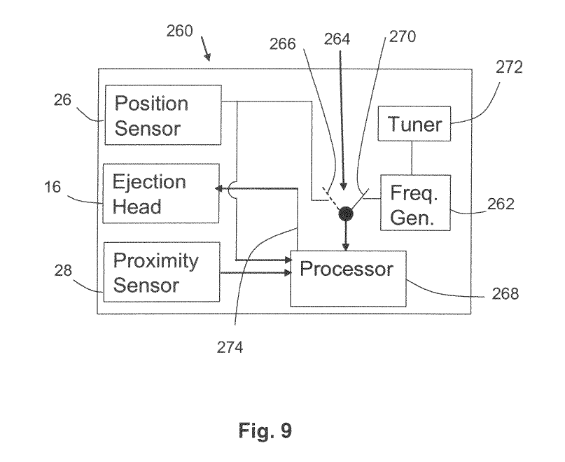

FIG. 9 presents a block diagram of a printing apparatus 260 that incorporates a position sensor 26 that may optionally be used for control of print spacing during translational motion of the printing apparatus 260. An independent frequency generator 262 is also provided. A switch 264 is provided to switch between a configuration where (when the switch 264 is in position 266) positional data from position sensor 26 is provided to processor 268 and a configuration (when the switch 264 is in position 270) where frequency generator 262 produces pulses at a designated frequency that are fed to a processor 268.

In other embodiments a tuner 272 may be provided to manually adjust the designated frequency of frequency generator 262. The processor 268 provides print trigger signals 274 to ejection head 16.

There are several advantages to providing a printer that has the option of either automatically adjusting the print spacing to conform to the actual translational motion of the printing apparatus or of providing print trigger signals independent of actual translational motion. One advantage is that it gives an additional element of artistic choice to the operator. Another advantage is that switch 264 may be used as an override to print in circumstances where the position sensor 26 does not automatically enable ink ejection, such as in an operation to print bursts of ink into a tissue or a garbage can in order to clean the micro-fluid ejection head.

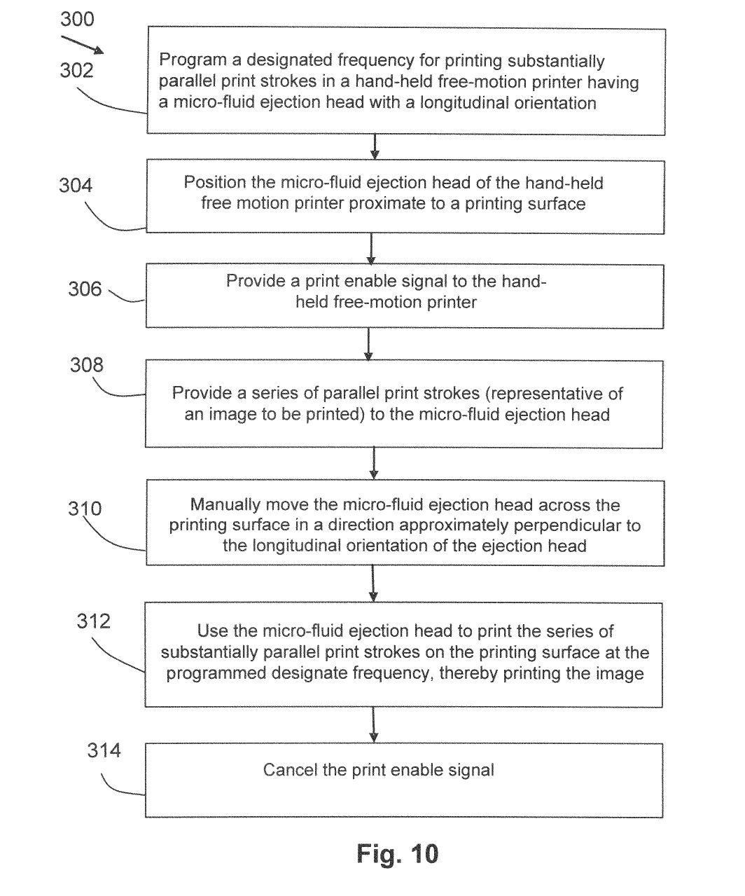

FIG. 10 presents as flow chart for a method 300 for printing an image using a hand-held free-motion printer. In step 302 a printer, the printer having a micro-fluid ejection head, is programmed with a designated frequency for manually printing substantially parallel print strokes. In step 304, the micro-fluid ejection head of the hand-held printer is manually positioned proximate to a printing surface. In step 306 a start of print indication is provided to the hand-held printer. In step 308 a series of print strokes are provided to the micro-fluid ejection head. The print strokes have parallel longitudinal orientations, and the print strokes represent an image to be printed. In step 310 the micro-fluid ejection head is manually moved across the printing surface in a direction approximately perpendicular to the longitudinal orientation of the ejection head. In step 312 the micro-fluid ejection head is used to print the series of substantially parallel print strokes on the printing surface at the programmed designated frequency, thereby printing the image. The print enable signal is then cancelled in step 314.

In other exemplary embodiments of method 300, a signal indicative of the spatial location of the micro-fluid ejection head with respect to the target area is provided to the hand-held printer. In such embodiments the hand-held printer is configured to operate an open-loop with respect to the relative translational motion between the printing apparatus and the target area. By knowing the spatial location of the micro-fluid ejection head, the printer may select a subset of the series of substantially parallel print strokes corresponding to the spatial location of the micro-fluid ejection head with respect to the target area. The term “applicable to the spatial location” means that the selected print strokes represent the portion of the image that corresponds to that spatial location. The printer then prints the selected subset of print strokes at that spatial location.

In another exemplary embodiment spatial location information is used to inhibit printing of portions of an image. For example, if the spatial location of the micro-fluid ejection head is outside the target area, that information may be used to disable printing. Also, if the spatial location of the micro-fluid ejection head is at a location where print strokes were previously printed, that information may be used to disable printing.

As indicated earlier herein, the previous discussion provides illustrations of a micro-fluid ejection device that is a handheld printing device, but these exemplary embodiments may be applied to any generalized handheld micro-fluid ejection device such as devices used for ejecting cooling fluids, lubricants, pharmaceuticals, and the like on a wide variety of surfaces. Such generalized handheld micro-fluid ejection devices include printers. When adapting the previous illustrations to these generalized devices Table 1 provides examples of term substitutions that may be applied.

TABLE 1

| Printing Device Term | Equivalent Generalized Device Term |
|---|---|
| printing apparatus | micro-fluid ejection device |
| printing an image | ejecting a fluid |
| printing surface | substrate surface |
| print stroke | fluid ejection stroke |
| | [or] |
| | droplet ejection stroke |
| print stroke frequency | fluid ejection stroke frequency |
| | [or] |
| | droplet ejection stroke frequency |
| print trigger | ejection signal |
| macro element present in the | macro element of fluid droplets |
| image | on a substrate |
| to print a macro element | To eject a macro element of fluid |
| | droplets onto the substrate |

The foregoing descriptions of exemplary embodiments of disclosure have been presented for purposes of illustration and exposition. They are not intended to be exhaustive or to limit the disclosed embodiments to the precise forms disclosed. Obvious modifications or variations are possible in light of the above teachings. The embodiments are chosen and described in an effort to provide the best illustrations of the principles of the exemplary embodiments and their practical application, and to thereby enable one of ordinary skill in the art to utilize the disclosed embodiments with various modifications as are suited to the particular use contemplated. All such modifications and variations are within the scope of the exemplary embodiments as determined by the appended claims when interpreted in accordance with the breadth to which they are fairly, legally, and equitably entitled.

What is claimed is:

1. A hand-held micro-fluid ejection device for ejecting a fluid onto a substrate surface during relative translational motion between the ejection device and a target area of the substrate surface, the device comprising:
a frequency generator configured to operate open-loop with respect to the relative translational motion between the micro-fluid ejection device and the target area, the frequency generator further configured to generate a designated frequency spectrum signal, the designated frequency spectrum signal comprising a fluid ejection frequency component that is substantially equal to an expected translational velocity of the hand-held micro-fluid ejection device across the target area divided by a fluid ejection stroke spacing distance;
an electronic processor configured to receive the designated frequency spectrum signal from the frequency generator and configured to generate a series of ejection signals embodying a plurality of linear arrays of fluid droplets representative of fluid ejected onto the substrate surface when the linear arrays of fluid droplets are arranged sequentially at the fluid ejection stroke spacing distance and embodying the designated frequency spectrum signal; and
a micro-fluid ejection head configured to receive the series of parallel ejection signals and configured to use the series of ejection signals to eject a series of fluid droplets at the fluid ejection frequency.

2. The micro-fluid ejection device of claim 1 further comprising a position sensor and a display, the position sensor being configured to provide a signal indicative of the spatial location of the micro-fluid ejection head relative to the target area, wherein the electronic processor is configured to utilize the signal indicative of the spatial location of the micro-fluid ejection head to provide information via the display regarding the spatial location of the micro-fluid ejection head relative to the target area.

3. The micro-fluid ejection device of claim 1 further comprising a position sensor, the position sensor being configured to provide a signal indicative of the spatial location of the micro-fluid ejection head relative to the target area, wherein the electronic processor is configured to generate the series of fluid ejection signals only when the micro-fluid ejection head is within the target area.

4. The micro-fluid ejection device of claim 1 further comprising a first manual control to adjust the fluid ejection frequency.

5. The micro-fluid ejection device of claim 4 wherein:
the electronic processor is further configured to generate a series of macro element signals corresponding to macro elements of fluid droplets on a substrate at a defined macro element spacing distance,
the designated frequency spectrum signal further comprises a macro element frequency component generated by the frequency generator, the macro element frequency component corresponding to the expected translational velocity of the micro-fluid ejection device across the target area divided by the macro element spacing distance, and
the micro-fluid ejection head is further configured to use the series of macro element signals to eject fluid droplets at the macro element frequency.

6. The micro-fluid ejection device of claim 5 further comprising a position sensor and a display, the position sensor being configured to provide a signal indicative of the spatial location of the micro-fluid ejection head relative to the target area, wherein the electronic processor is configured to utilize the signal indicative of the spatial location of the micro-fluid ejection head to provide information via the display regarding the spatial location of the micro-fluid ejection head relative to the target area.

7. The micro-fluid ejection device of claim 5 further comprising a position sensor, the position sensor being configured to provide a signal indicative of the spatial location of the micro-fluid ejection head relative to the target area, wherein the electronic processor is configured to generate the series of ejection signals only when the micro-5 fluid ejection head is within the target area.

8. The micro-fluid ejection device of claim 5 further comprising a manual control to adjust the macro element frequency.

9. The micro-fluid ejection device of claim 1 wherein:
the electronic processor is further configured to generate a series of macro element signals corresponding to macro elements of fluid droplets on a substrate at a defined macro element spacing distance, and
the designated frequency spectrum signal further comprises a macro element frequency component generated by the frequency generator, the macro element frequency component corresponding to the expected translational velocity of the hand-held free-motion printing apparatus across the target area divided by the macro element spacing distance, and
the micro-fluid ejection head is further configured to use the series of macro element signals to eject a macro element of fluid droplets onto the substrate at the macro element frequency.

10. The micro-fluid ejection device of claim 1 wherein the micro-fluid head comprises at least a first redundant micro-fluid ejector.

11. A hand-held micro-fluid ejection device for ejecting fluid droplets in a predetermined pattern on a substrate during relative translational motion between the ejection device and a target area of the substrate, the ejection device comprising:
a position sensor configured to provide a signal indicating the actual rate of relative translational motion between the ejection device and the target area of the substrate;
a frequency generator configured to operate open-loop with respect to the relative translational motion between the ejection device and the target area, the frequency generator configured to generate a designated frequency spectrum signal, the designated frequency spectrum signal comprising a droplet frequency component that is substantially equal to an expected translational velocity of the ejection device across the target area divided by a droplet spacing distance;
a switch configured to provide an ejection pulse signal, the switch having a first position and a second position such that when the switch is in the first position the switch passes as the ejection pulse signal from the position sensor indicating an actual rate of relative translational motion between the ejection device and the target area of the substrate and when the switch is in the second position the switch provides as the ejection pulse signal the designated frequency spectrum signal;
an electronic processor configured to receive the ejection pulse signal from the switch and configured to derive a droplet ejection frequency signal from the ejection pulse signal and configured to generate a series of ejection signals embodying a plurality of droplets representative of the predetermine pattern when the droplets are arranged sequentially at the droplet ejection spacing distance and embodying the droplet frequency signal; and
a micro-fluid ejection head configured to receive the series of parallel ejection signals and configured to use the series of ejection signals to deposit fluid droplets at the droplet ejection frequency to provide the predetermine pattern of droplets on the substrate.

12. The micro-fluid ejection device of claim 11 wherein the position sensor is configured to use a quadrature signal to generate the indication of the actual rate of relative motion between the ejection device and the target area.

13. The micro-fluid ejection device of claim 11 further comprising a position sensor and a display the position sensor being configured to provide a signal indicative of the spatial location of the micro-fluid ejection head relative to the target area, wherein the electronic processor is configured to utilize the signal indicative of the spatial location of the micro-fluid ejection head to provide information via the display regarding the spatial location of the micro-fluid ejection head relative to the target area.

14. The micro-fluid ejection device of claim 11 further comprising a position sensor, the position sensor being configured to provide a signal indicative of the spatial location of the micro-fluid ejection head relative to the target area, wherein the electronic processor is configured to generate the series of ejection signals only when the micro-fluid ejection head is within the target area.

15. The micro-fluid ejection device of claim 11 further comprising a manual control to adjust the droplet ejection frequency.

16. A method for printing an image during relative translational motion between a hand-held printing apparatus and a target area of a printing surface, the method comprising:
a) programming a designated frequency for manually printing substantially parallel print strokes into a hand-held free-motion printer having a micro-fluid ejection head with a longitudinal orientation;
b) manually positioning the micro-fluid ejection head of the hand-held printer proximate to the printing surface;
c) providing a print enable signal to the hand-held printer, the print enable signal being valid until cancellation;
d) providing a series of substantially parallel print strokes representative of a desired printed image to micro-fluid ejection head;
e) manually moving the micro-fluid ejection head across the printing surface in a direction approximately perpendicular to the longitudinal orientation of the ejection head;
f) while the print enable signal is valid, using the micro-fluid ejection head to print the series of substantially parallel print strokes on the printing surface at the programmed designated frequency, thereby printing the image; and
g) cancelling the print enable signal.

17. The method of claim 16 further comprising
providing to the hand-held printer a signal indicative of the spatial location of the micro-fluid ejection head with respect to the target area prior to step (c);
using the signal indicative of the spatial location of the micro-fluid ejection head with respect to the target area to select a subset of the series of substantially parallel print strokes the subset being applicable to the spatial location of the micro-fluid ejection head with respect to the target area, and
using the micro-fluid ejection head to print the selected subset of series of substantially parallel print strokes on the printing surface at the programmed designated frequency thereby printing a portion of the image.

18. The method of claim 16 further comprising manually adjusting the designated frequency for manually printing substantially parallel print strokes.

19. The method of claim 16 further comprising:
providing a signal indicative of the spatial location of the micro-fluid ejection head with respect to the target area, prior to step (c);
and using the signal indicative of the spatial location of the micro-fluid ejection head to at least in part provide the print enable signal to the hand-held printer.

20. The method of claim 19 further comprising the steps:
storing as an original spatial location the spatial location of the micro-fluid ejection head relative to the target area for the spatial location where a valid print enable signal has been provided to the hand-held printer; and
cancelling the print enable signal when the micro-fluid ejection head is at a duplicated spatial location, the duplicated spatial location being any spatial location substantially the same as any original spatial location where a valid print enable signal has been provided to the hand-held printer.
